(19) United States
(12) Patent Application Publication
(10) Pub. No.: US 2013/0208181 A1
(43) Pub. Date: Aug. 15, 2013

(54) Novelty camera attachment

(71) Applicants: John James, Prosper, TX (US); Amy James, Prosper, TX (US); Randy Brookings, Corsicana, TX (US); Susan Brookings, Corsicana, TX (US)

(72) Inventors: John James, Prosper, TX (US); Amy James, Prosper, TX (US); Randy Brookings, Corsicana, TX (US); Susan Brookings, Corsicana, TX (US)

(21) Appl. No.: 13/385,263

(22) Filed: Feb. 10, 2012

(51) Int. Cl. H04N 5/225

(52) U.S. Cl. 348/375; 348/E05.025

(57) ABSTRACT

The invention disclosed herein provides an apparatus, system and method for attracting the gaze of a subject being photographed so that better photographs can be made. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### TECHNICAL FIELD OF THE INVENTION

The present invention relates to camera attachments.

### PROBLEM STATEMENT

1. Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

2. Discussion

Catching the attention of a subject being photographed is sometimes a challenge, particularly if the subject is a young child or pet. The invention disclosed herein provides an apparatus, system and method for attracting the gaze of a subject being photographed so that better photographs can be made.

### BRIEF DESCRIPTION OF THE DRAWINGS

Various aspects of the invention, as well as an embodiment, are better understood by reference to the following detailed description. To better understand the invention, the detailed description should be read in conjunction with the drawings and tables, in which:

FIG. 1 illustrates an inventive novelty camera attachment attached to a camera.

FIG. 2 is a side-view of the inventive novelty camera attachment attached to a camera.

FIG. 3 is a block-diagram of an inventive novelty camera attachment coupled to a camera.

### DETAILED DESCRIPTION OF THE INVENTION

### Interpretation Considerations

When reading this section (which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise. The numerous innovative teachings of present application are described with particular reference to presently preferred embodiments.

### DESCRIPTION OF THE DRAWINGS

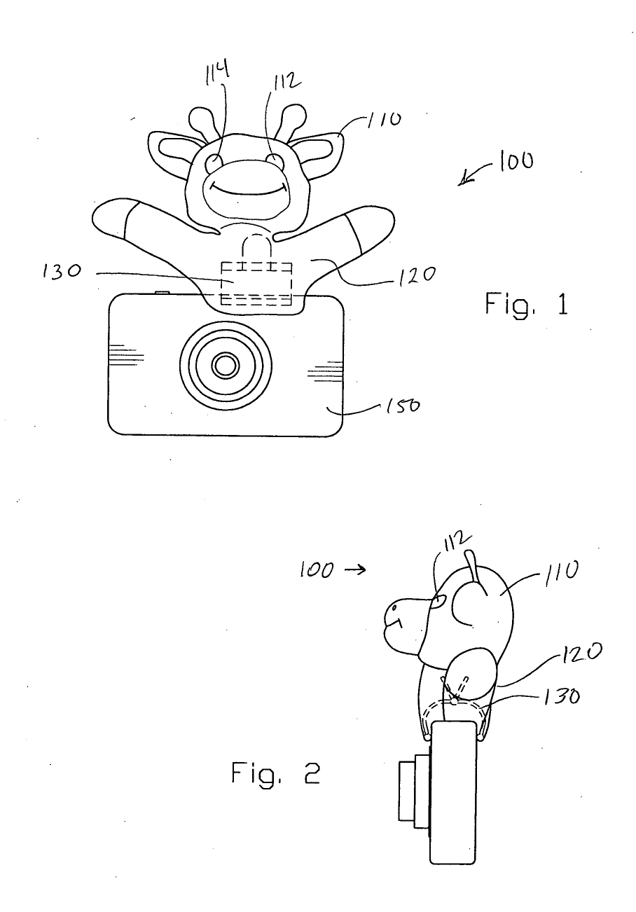

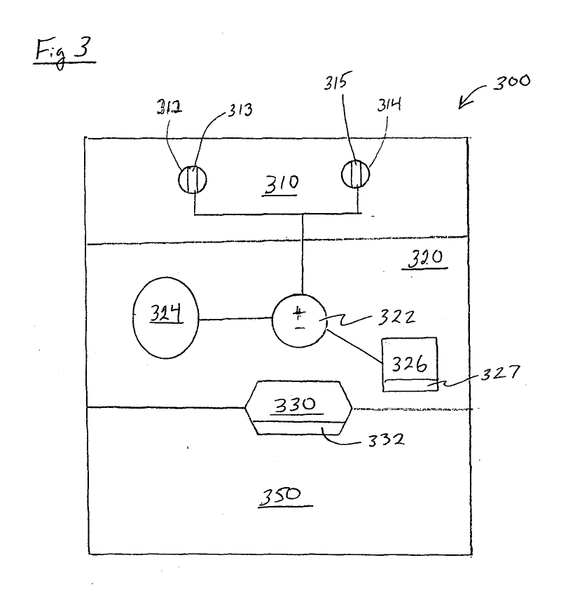

Simultaneous reference is made to the Figures, in which FIG. 1 illustrates an inventive novelty camera attachment attached to a camera, FIG. 2 is a side-view of the inventive novelty camera attachment attached to a camera, and FIG. 3 is a block-diagram of an inventive novelty camera attachment coupled to a camera. References to FIG. 3 are numbered with a “300” number series.

In one embodiment, the invention is an apparatus for catching the attention of a subject being photographed 100 (or 300). The apparatus 100 has an attention attracting portion comprising a facial portion 110 (or 310) and a body portion 120 (or 320). The facial portion 110 has a first eye 112 (or 312) having therein a first LED shown in FIG. 3 as 313, and a second eye 114 (or 314) having therein a second LED 315. The body portion 120 is coupled to the facial portion 110 and thereby creating the appearance of a plush toy. Additionally, the facial portion 110 may have the face of an animal or a plant, such as a flower, or may have a “generic” face such as those used with toys and shown on videos for children.

The body portion 120 comprises a battery 332. The battery 332 is electrically coupled to an actuator 326 which articulates the facial portion when powered. The battery 322 is also coupled to the first LED 313 and second LED 315, the first LED 313 and second LED 315 light-up when powered, and may flash, rotate colors or provide other features. In addition, the battery 322 is also coupled to an audio device 324 which plays a sound when powered. In one embodiment the actuator 326 includes a control device 327 that synchronizes the audio device 324, LEDs 313, 315 and actuator 326 so that the facial portion and body portion have a realistic and friendly animated appearance.

Furthermore, a camera coupling 130, shown in FIG. 1 as a clamp, couples the body portion 120 to a pocket sized digital camera 150 (or 350). Other couplings include magnet 332, Velcro®, and threaded screw or nut that specifically mate with cameras, such as on the flash-coupling of a camera, for example. Likewise, the camera 150 may be a typical pocket camera, camera-phone/personal digital assistant, or equivalent. However, in alternative embodiments, the camera may be a traditional professional-style camera with a detachable lens.

Though the invention has been described with respect to specific preferred embodiments, many variations and modifications will become apparent to those skilled in the art upon reading the present application. Specifically, the invention may be altered in ways readily apparent to those of ordinary skill in the art upon reading the present disclosure. It is therefore the intention that the appended claims and their equivalents be interpreted as broadly as possible in view of the prior art to include all such variations and modifications.

I claim:

1. An apparatus for catching the attention of a subject being photographed, comprising:
an attention attracting member comprising
a facial portion,
a body portion coupled to the facial portion,
the body portion comprising a camera coupling.

2. The apparatus of claim 1 wherein the facial portion is an animal face.

3. The apparatus of claim 1 wherein the facial portion is a flower.

4. The apparatus of claim 1 wherein the camera coupling is a clamp.

5. The apparatus of claim 1 wherein the camera coupling is a hook-and-loop material.

6. The apparatus of claim 1 wherein the camera coupling comprises a first coupling member that mates with a second coupling member that is attached to a camera.

7. The apparatus of claim 1 further comprising a camera attached to the camera coupling.

8. The apparatus of claim 1 wherein the camera coupling is a threaded nut that is attachable to a camera.

9. The apparatus of claim 1 further comprising an audio playing component.

10. The apparatus of claim 1 further comprising an LED disposed in the facial portion.

11. The apparatus of claim 10 wherein the LED is a flashing LED.

12. The apparatus of claim 1 wherein the facial portion comprises two eyes.

13. The apparatus of claim 12 wherein the two eyes each comprises an LED.

14. The apparatus of claim 4 wherein the clamp resides in the interior of the body portion.

15. The apparatus of claim 1 wherein the camera coupling comprises a magnet.

16. The apparatus of claim 1 wherein the facial portion and the body portion form a plush toy.

17. The apparatus of claim 7 wherein the camera is a pocket-sized digital camera.

18. The apparatus of claim 1 wherein the body comprises an actuator that articulates the facial portion and body portion.

19. An apparatus for catching the attention of a subject being photographed, comprising:
an attention attracting member comprising
a facial portion having a first eye having therein a first LED, and a second eye having therein a second LED,
a body portion coupled to the facial portion and thereby creating the appearance of a plush toy,
the body portion comprising a battery,
the battery coupled to an actuator, the actuator articulates the facial portion when powered,
the battery also coupled to the first LED and second LED, the first LED and second LED light-up when powered,
the battery also coupled to an audio device, the audio device plays a sound when powered, and
a camera coupling clamp that coupled the body portion to a pocket sized camera.
